(19) United States
(12) Patent Application Publication
(10) Pub. No.: US 2013/0333188 A1
(43) Pub. Date: Dec. 19, 2013

(54) METHOD FOR MANUFACTURING CONSTRUCTIVE ELEMENTS AND CONSTRUCTIVE ELEMENTS MADE THEREBY

(71) Applicant: A.A.H. PLAST LTD., Beer-Sheva (IL)

(72) Inventor: Eli HAIM, Omer (IL)

(21) Appl. No.: 13/916,656

(22) Filed: Jun. 13, 2013

Related U.S. Application Data
(60) Provisional application No. 61/659,532, filed on Jun. 14, 2012.

(51) Int. Cl. F17C 1/16

(52) U.S. Cl. CPC F17C 1/16
USPC 29/428

(57) ABSTRACT

The present invention relates to lids and sealing elements for cylindrical bodies, made by extruding layers of plastic material. More particularly, the invention relates to a method in which lids and sealing elements are manufactured and then connected to the cylindrical bodies. This method permits absolute sealing and prevents a significant waste of material.

### FIELD OF THE INVENTION

The present invention relates to lids and sealing elements for cylindrical bodies, made by extruding layers of plastic material. More particularly, the invention relates to a method in which lids and sealing elements are manufactured and then connected to the cylindrical bodies. This method permits absolute sealing and prevents a significant waste of material.

### BACKGROUND OF THE INVENTION

Cylindrical tanks made of plastic materials are used for the storage of liquids and other materials, e.g., particulate solids. The tanks are used for the storage of many different materials and therefore need to be suitable for different conditions, such as temperature, density and weight. The suitability of the tank to its intended use is a function of the diameter, height and thickness of the tank. Since the bottom lid of the tank (also referred to herein simply as “bottom”) endures great amount of pressure, it is crucial to make the connection as strong as possible, and to design the lid with the appropriate geometry suitable to endure the pressure.

The thickness of the lid also influences its strength, and should be taken under consideration as well. In a layered material this quality will be determined by the number of layers used to produce the lid.

Nowadays, methods for manufacturing lids cause great loss of material, and offer a limited size of diameter and thickness, since the lids cannot be shaped properly from certain sizes. A smaller diameter forces a higher tank, and therefore causes higher pressure on the bottom lid. In addition, in some conventional processes the lid is formed out of square shaped plates that are attached to one another by welding or gluing, and therefore have several weakness points, since every attachment weakens the material's endurance to pressure. This process also requires a great deal of work.

Cylindrical tanks are manufactured according to one particular technique known in the art, by extruding onto a cylindrical form strips of various dimensions, and by providing a number of layers of said strips that determine the thickness of the tank. An example of this method is described in U.S. Pat. No. 6,102,241.

To date the prior art has failed to provide an efficient method for manufacturing lids for tanks, It is an object of the present invention to provide a method that significantly improves the product and allows an efficient and faster manufacturing process while preventing waste of materials.

Other objectives and advantages of the invention will become apparent as the description proceeds.

### SUMMARY OF THE INVENTION

The invention relates to a method for manufacturing constructive elements, comprising:
a) Providing a cylindrical element made by wrapping at least one layer of strips of plastic material around a heated cylinder;
b) Cutting said cylindrical element to create a substantially flat surface therefrom;
c) Cutting from said substantially flat surface shapes adapted to create constructive elements by no more than one connection; and
d) Connecting surfaces of said shapes needed to create the desired shaped element.

In one embodiment of the invention the shape cut from the flat surface is circular in shape. In another embodiment of the invention the shape cut from the flat surface is the precursor of a cone.

There is no limitation to the kind of constructive elements that can be manufactured according to the invention and they may be, for instance, a lid of a tank or other vessel, and they may further be reinforced by supporting beams made from the same material and cut out of the flat surface.

Different parts of the constructive elements can be joined using any suitable technique and, in one embodiment of the invention the connecting is made by gluing, while in another the connecting is made by welding.

The invention also encompasses constructive elements, whenever manufactured by the method of the invention.

### BRIEF DESCRIPTION OF THE DRAWINGS

In the drawings:

FIG. 1 schematically illustrates the process for forming a cylindrical body according to U.S. Pat. No. 6,102,241;

FIGS. 2 (A and B) schematically illustrates two different embodiments of the invention;

FIG. 3 is a cone shaped lid with beams. Manufactured according to the invention; and

FIGS. 4 (A and B) schematically illustrates an embodiments of a lid, in an inside view shown in two different ways, i.e., using shading and using geometrical lines.

### DETAILED DESCRIPTION OF THE INVENTION

The method for manufacturing shaped elements, such as lids for tanks or other parts thereof, is performed by extruding strips that are made of extruded plastic material, on a cylindrical form. The plastic material is heated, and shaped as strips that later on are placed upon a cylindrical form, as described in U.S. Pat. No. 6,102,241. After forming the strips on the cylindrical form, according to the invention a cut is performed along the form, allowing the detachment of the plastic material from the form. This product can be shaped in any desired shape, e.g. as a plate or a cone, and can be used as a lid for tanks or as a constructive element, by applying pressure.

The fact that only a single cut has been made, allows attaching the body back together, after forming its shape, by welding or gluing only that single cut. This method provides greater strength and endurance for pressure than methods that require welding multiple pieces to create a desired shape.

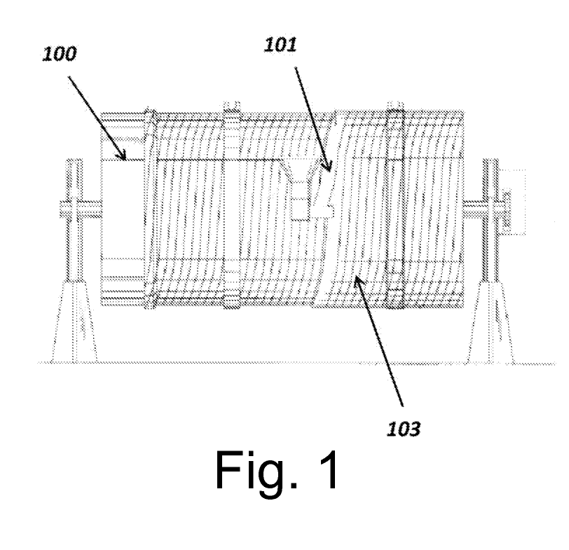

Referring to FIG. 1, a strip 101 is extruded and wound onto a cylinder 100 to create a layered, tubular body 103, made of layers of strip that because of their temperature form a solid body, as described in U.S. Pat. No. 6,102,241.

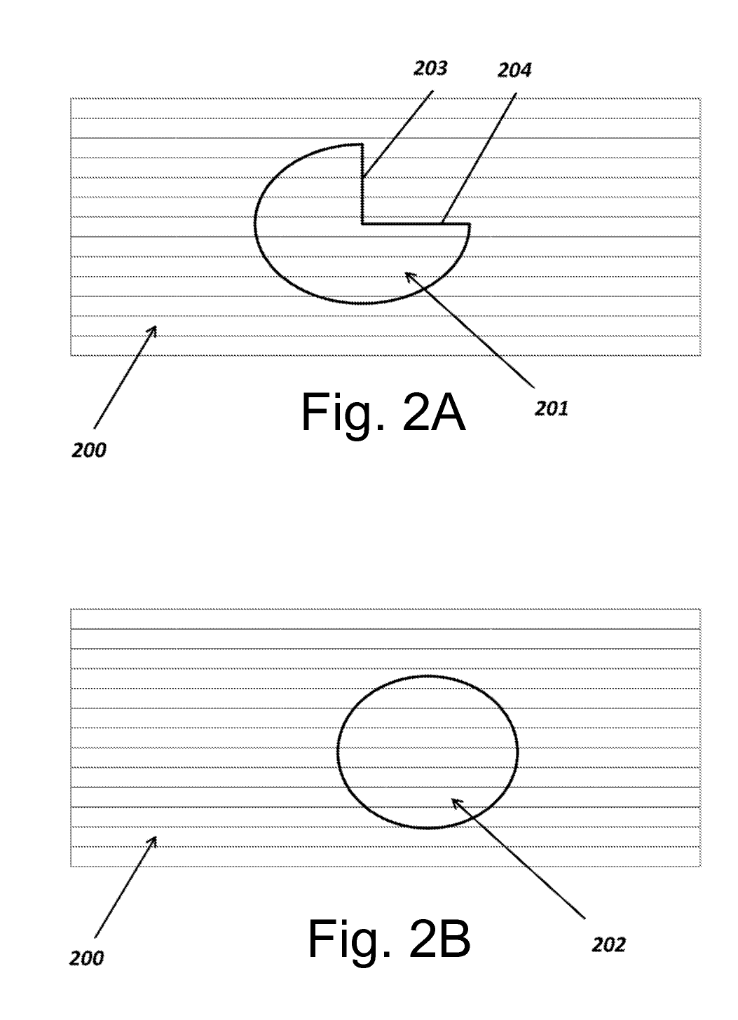

FIG. 2 shows two examples of use according to the invention, after cylindrical body 101 has been cut along its length and placed on a flat surface, to yield layered flat surface 200. In FIG. 2A shape 201 is cut out of surface 200, which is later used to create a conic element, as will be further explained below. In FIG. 2B, on the other hand, a circular element 202 is cut out of surface 200, which can be used directly, e.g., as a lid for a cylindrical vessel.

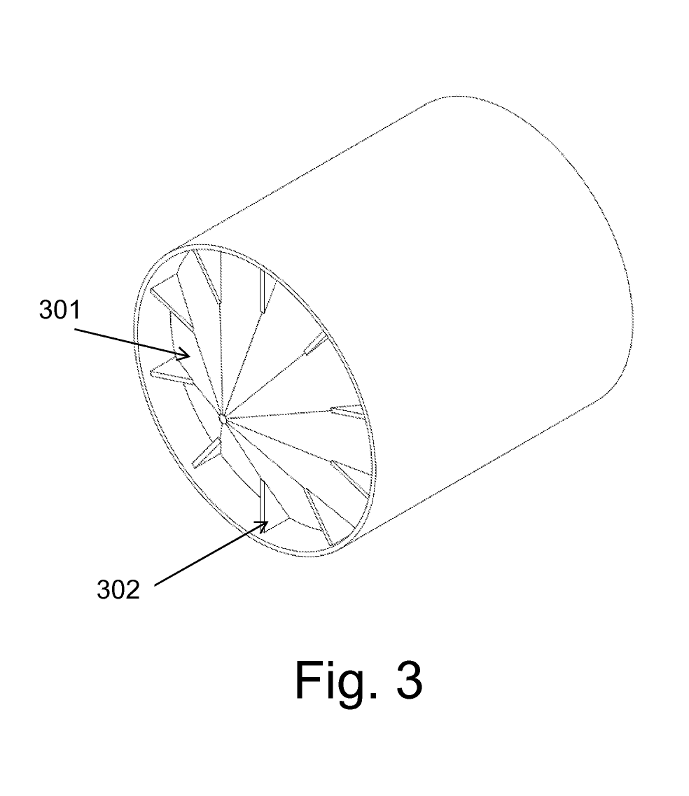

In FIG. 3 a reinforced, conical structural element is shown, which was made essentially as schematically illustrated by FIG. 2A, by joining the two edges, 203 and 204 together and welding them. After the exterior part of the element 301 is done, the material left is used for building internal supporting beams 302. That way all parts are made of the same material, and therefore the attachments are stronger, and there is little waste of constructive material.

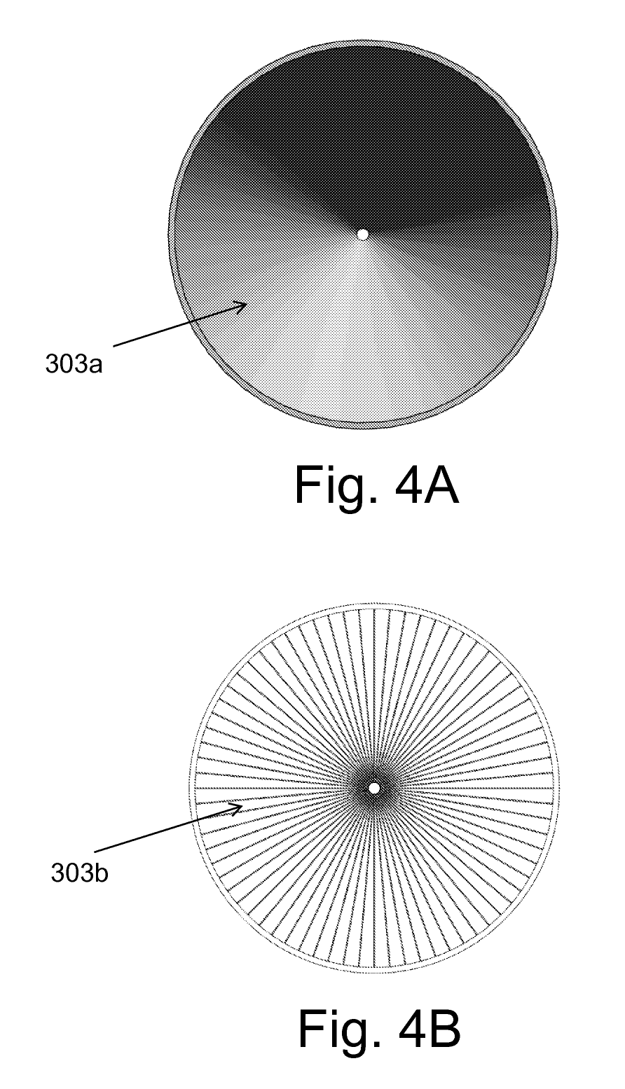

FIG. 4 shows the two FIGS. 4A and 4B, which schematically illustrate the constructive element of FIG. 3 from the back. The figure is provided in two forms to make it easier to visualize the back of the cone. It can be seen that the back portion 303a, which is the part that was in contact with heated cylinder 100 (FIG. 1) is essentially smooth. The back portion 303b represents the same smooth part that was in contact with the cylinder, but has additional lines toward the center, in order to demonstrate the depth of the cone.

All above description has been provided for the purpose of illustration and is not intended to limit the invention in any way, except as defined by the claims to follow.

1. A method for manufacturing constructive elements, comprising:
a) Providing a cylindrical element made by wrapping at least one layer of strips of plastic material around a heated cylinder;
b) Cutting said cylindrical element to create a substantially flat surface therefrom;
c) Cutting from said substantially flat surface shapes adapted to create constructive elements by no more than one connection; and
d) Connecting surfaces of said shapes needed to create the desired shaped element.

2. A method according to claim 1, wherein the shape cut from the flat surface is circular in shape.

3. A method according to claim 2, wherein the shape cut from the flat surface is the precursor of a cone.

4. A method according to claim 3, wherein the element is a lid of a tank or other vessel.

5. A method according to claim 3, wherein the supporting beams are cut out of the flat surface.

6. A method according to claim 1, wherein the connecting is made by gluing.

7. A method according to claim 1, wherein the connecting is made by welding.

8. A constructive element, whenever manufactured by the method of claim 1.
